(19) United States
(12) Patent Application Publication
(10) Pub. No.: US 2003/0020916 A1
(43) Pub. Date: Jan. 30, 2003

(54) Optical detection device

(76) Inventors: Shay Ghilai, Tel Aviv (IL); Zeev Mairav, Hod Hasharon (IL); Yafim Smolyak, Ramat Gan (IL); Noam Noy, Natanya (IL)

Correspondence Address: MERCHANT & GOULD PC, P.O. BOX 2903, MINNEAPOLIS, MN, 55402-0903, US

(21) Appl. No.: 09/569,138

(22) Filed: May 11, 2000

(51) Int. Cl. G01N 21/55

(52) U.S. Cl. 356/445

(57) ABSTRACT

System for inspecting a surface, the system including a light source, a first transparent mirror, and a detector, wherein the light source projects a first light beam on the first transparent mirror, the first transparent mirror reflects the first light beam towards the surface in a direction normal to the surface, and wherein the detector detects a second light beam reflected from the surface, in a normal direction, through the first transparent mirror.

### FIELD OF THE INVENTION

The present invention relates to light detection systems in general, and to methods and systems for inspecting reflective surfaces and objects, in particular.

### BACKGROUND OF THE INVENTION

Systems for detecting surface anomalies are known in the art. These systems detect changes in surface properties of continues strips of reflective surfaces, and defects in objects moving on a conveyor system. Such surface properties include printed matter in a press, detection of lacquer quality and thickness thereof on printed matter, cold seal of packages, color of metals and the like. Defects include burrs and corrosion on metals, defects in sharp edges of knives and the like.

It will be appreciated by those skilled in the art that the detection reflective of any detail of a reflective material is problematic due to the high intensity of light, which is reflected from the reflective material towards the detector.

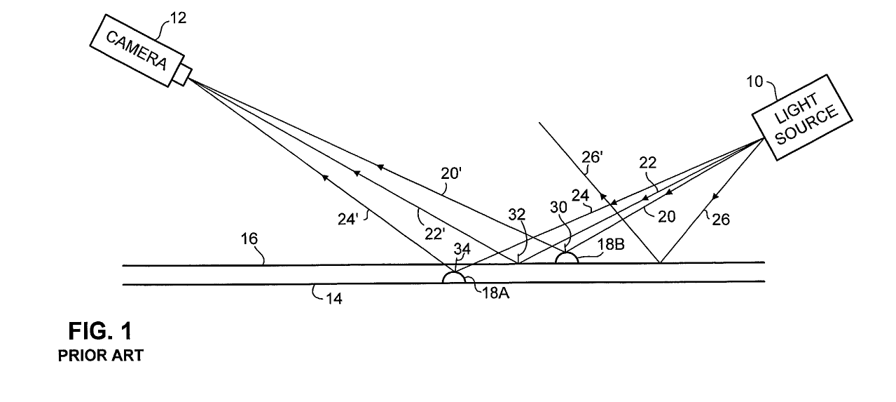

Reference is now made to FIG. 1, which is a schematic illustration of a detection system, known in the art. The system includes a light source 10 and a camera 12. The light source produces a plurality of light rays 20, 22 and 24 which are directed at an inspected surface 14, which has a reflective semi-transparent layer 16. The surface 14 incorporates two particles 18A and 18B. The term “particle” herein after refers to foreign particles with respect to reflective semi-transparent layer 16, such as dust, debris, solid matter, and the like. Light ray 20 is reflected from particle 18B, as a light ray 20′ about an axis of symmetry 30, normal to surface of particle 18B. Light ray 22 is reflected from reflective semi-transparent layer 16, as a light ray 22′ about an axis of symmetry 32, normal to reflective semi-transparent layer 16. Light ray 24 is reflected from particle 18A, as a light ray 24′ about an axis of symmetry 34, normal to surface of particle 18A. Detector 12 detects light rays 20′, 22′ and 24′.

A light ray 26 striking the reflective semi-transparent layer 16 away from particles 18A or 18B, is reflected sideways as a light ray 26′ from reflective semi-transparent layer 16, and is not detected by camera 12. It is noted that the light intensity of ray 22′ is significantly greater than of rays 20′ and 24′. The image, which is detected by camera 12, is affected by the intensity of the most powerful rays, detected thereby. Hence, the details, which are embedded in weaker rays, are likely to disappear in that image.

U.S. Pat. No. 4,291,990 to Takasu, is directed to an apparatus for measuring the distribution of irregularities on a mirror surface. The mirror surface may be a silicon wafer. The mirror surface to be inspected illuminated by means of a light source. Light surfaces reflected from the mirror surface are projected onto a screen by means of a half-mirror.

U.S. Pat. No. 5,331,397 to Yamanaka, et al. is directed to an inner lead bonding inspecting method and inspection apparatus. The pellet is to be inspected using the apparatus and is illuminated by means of a light source that is reflected onto pellet by means of half mirror. Reflections from the surface being inspected, are then transmitted through the same half mirror as indicated by beam and is picked up by the image pick-up device. The pick-up device may be a monochromatic ITV camera. The image signal from the image pick-up device is then transmitted to the measurement device and stored in an image memory for use by a measurement device. The images seen by the pick-up device may also be displayed on a monitor.

U.S. Pat. No. 5,497,234 to Haga is directed to an inspection apparatus for detecting marks formed on a sample surface. The system includes an illuminating device for a light source, which is projected onto the sample to be inspected by means of a beam splitter. The image from the sample is then reflected through collimator lens and back through the beam splitter and into camera tube.

U.S. Pat. No. 5,523,846 to Haga is directed to an apparatus for detecting marks formed on a sample surface. The light source is projected onto a sample surface through a half mirror. The light reflected from the surface is then returned to the half mirror through camera lens and projected onto a CCD.

U.S. Pat. No. 5,369,492 to Sugawara is directed to a bonding wire inspection apparatus. The sample is illuminated by a light source, which is deflected through half-mirror onto sample. The reflected light beam is then passed through half-mirror and is picked up by camera.

### SUMMARY OF THE INVENTION

It is an object of the present invention to provide a method and a system for inspecting reflective surfaces and objects, which overcomes the disadvantages of the prior art.

In accordance with the present invention there is thus provided, a system for inspecting a surface. The system includes a light source, a first transparent mirror and a detector. The light source projects a first light beam on the first transparent mirror, and the first transparent mirror reflects the first light beam towards the surface in a direction normal to the surface. Furthermore, the detector detects a second light beam reflected from the surface, in a normal direction, through the first transparent mirror.

The system further includes an image processor, connected to the detector, for processing at least one image detected by the detector, and a controller connected to the light source. The controller controls properties of the light source, such as the size of aperture, illumination intensity, radiation wavelength, illumination duration, intervals of illumination, and the like.

The system further includes a controller connected to the detector, whereby the controller controls the size of the aperture of the detector. The detector is either a charge coupled device (CCD), or a television camera, and the surface is either stationary or moving.

The system furthermore includes an optical condenser, located between the light source and the first transparent mirror. The system further includes a first screen located in sequence with the optical condenser and the first transparent mirror, along an axis, wherein the axis is determined by the light source and the first transparent mirror.

The system further includes a second transparent mirror, and a concave mirror. The second transparent mirror is located in sequence with the surface and the first transparent mirror, on an axis normal to the surface, wherein the axis is determined by the first transparent mirror. The concave mirror is located along an axis determined by the detector and the second transparent mirror. The second transparent mirror reflects the second light beam towards the concave mirror, and the detector detects a light beam reflected from the concave mirror through the second transparent mirror.

The system can further includes a second screen located in sequence with the first transparent mirror and the second transparent mirror, on an axis normal to the surface.

In accordance with another aspect of the present invention, there is thus provided a method for inspecting a surface. The method includes the steps of projecting a first light beam by a light source on a first transparent mirror, reflecting at least a portion of the first light beam by the first transparent mirror, in a direction normal to the surface, and detecting a second light beam reflected by the surface in a normal direction, through the first transparent mirror.

The method further includes the steps of collimating the first light beam, absorbing a passing portion of the first light beam, passing through the first transparent mirror, and reflecting at least a portion of the second light beam by a second transparent mirror, towards a concave mirror. The method can furthermore includes the steps of absorbing a passing portion of the second light beam, passing through the second transparent mirror, and detecting a light beam reflected by the concave mirror through the second transparent mirror.

In accordance with a further aspect of the present invention, there is thus provided a system for inspecting a surface. The system includes a detector, a light source, a transparent mirror, a mirror, and an optical condenser. The light source is located in sequence with the surface and the detector. The mirror is located in sequence with the surface and the transparent mirror.

The mirror reflects a first light beam received from the light source, towards the surface through the transparent mirror, in a direction normal to the surface. The transparent mirror reflects light towards the detector, wherein the light is initially reflected from the surface.

The transparent mirror reflects a second light beam, received from the light source, towards the surface, and the surface receives also a third light beam from the light source. The optical condenser is located between the mirror and the transparent mirror, wherein the optical condenser collimates a reflection of the first light beam, from the mirror towards the surface. The system further includes an image processor, and a controller. The image processor is connected to the detector, for processing at least one image detected by the detector. The controller is also connected to the light source. The controller controls properties of the light source, such as the size of aperture, illumination intensity, radiation wavelength, illumination duration, intervals of illumination, and the like.

The system can further include a controller connected to the detector, for controlling size of the aperture of the detector. The detector is either a charge coupled device (CCD), or a television camera, and the surface is either stationary or moving. It is noted that the same controller can be adapted to control both the detector and the light source.

In accordance with another aspect of the present invention, there is thus provided a system for inspecting a surface. The system includes a light source, a detector, a transparent mirror, and a concave mirror located in sequence with the detector and the transparent mirror. The light source projects a light beam towards the surface, and the transparent mirror reflects a portion of light towards the concave mirror, wherein the light is reflected from the surface. The concave mirror directs the portion of light towards the detector through the transparent mirror, and the detector detects the portion of light. The system further includes a screen located in sequence with the transparent mirror and the surface, on an axis normal to the surface.

In accordance with a further aspect of the present invention, there is thus provided a method for inspecting a surface. The method includes the steps of reflecting a first light beam, towards the surface, through a transparent mirror, and reflecting light, which is reflected from the surface, by the transparent mirror towards a detector. The method further includes the steps of detecting the light by the detector, reflecting a second light beam by the transparent mirror towards the surface, and projecting a third light beam towards the surface, wherein the first light beam, the second light beam, and the third light beam are produced by a single light source. The method can further include the step of collimating a reflection of the first light beam.

### BRIEF DESCRIPTION OF THE INVENTION

The present invention will be understood and appreciated more fully from the following detailed description taken in conjunction with drawings in which:

FIG. 1 is a schematic illustration of a detection system, known in the art;

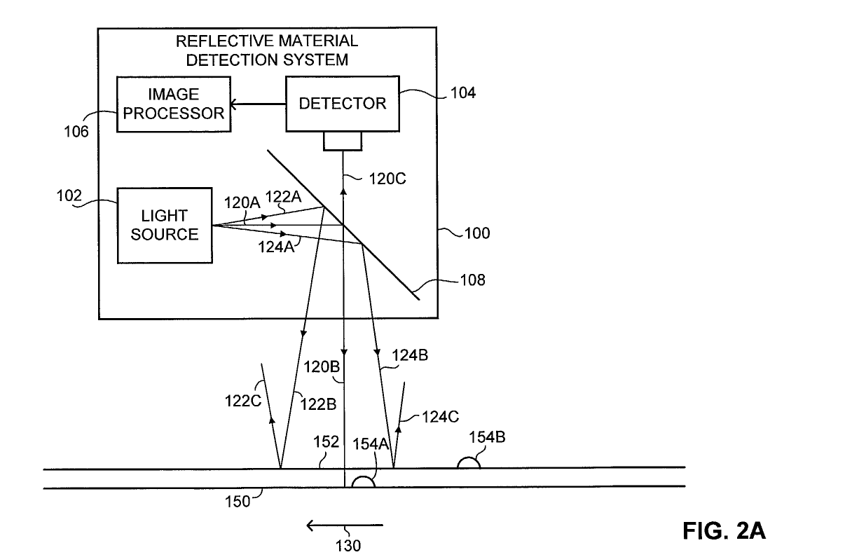

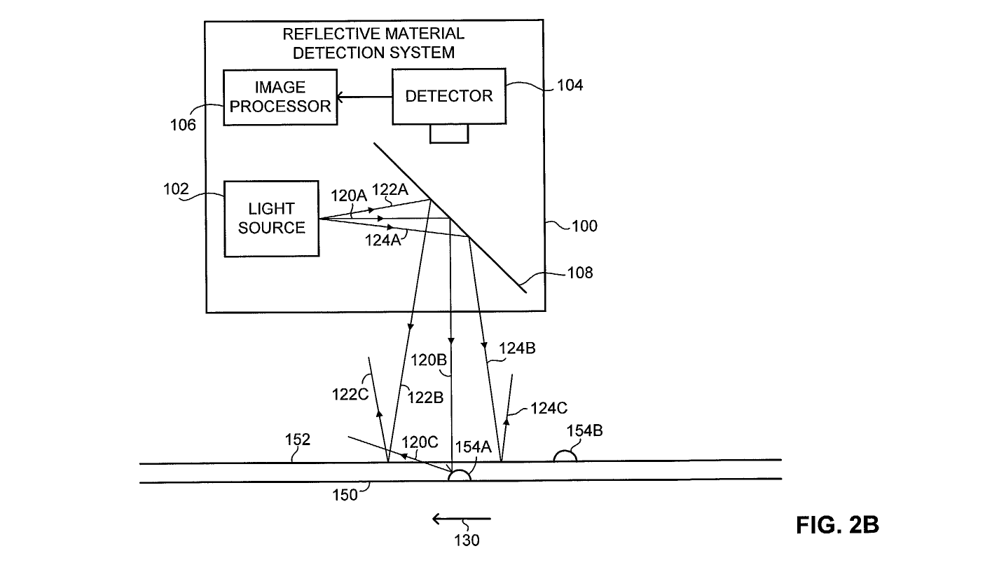

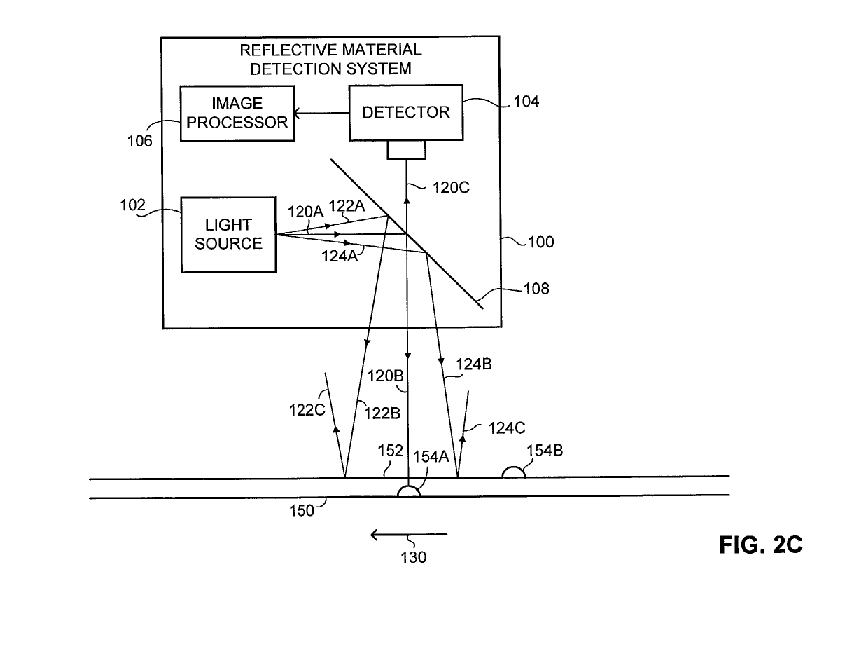

FIG. 2A is a schematic illustration of a moving sample, having a transparent coating and a detection system, constructed and operative in accordance with a preferred embodiment of the present invention;

FIGS. 2B and 2C are schematic illustrations of the moving sample and the detection system of FIG. 2A, at different positions;

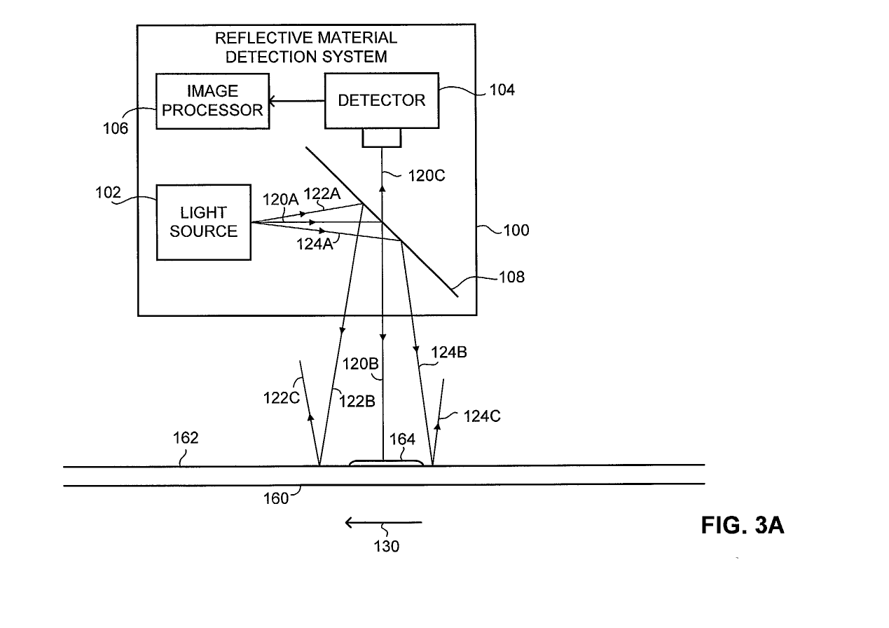

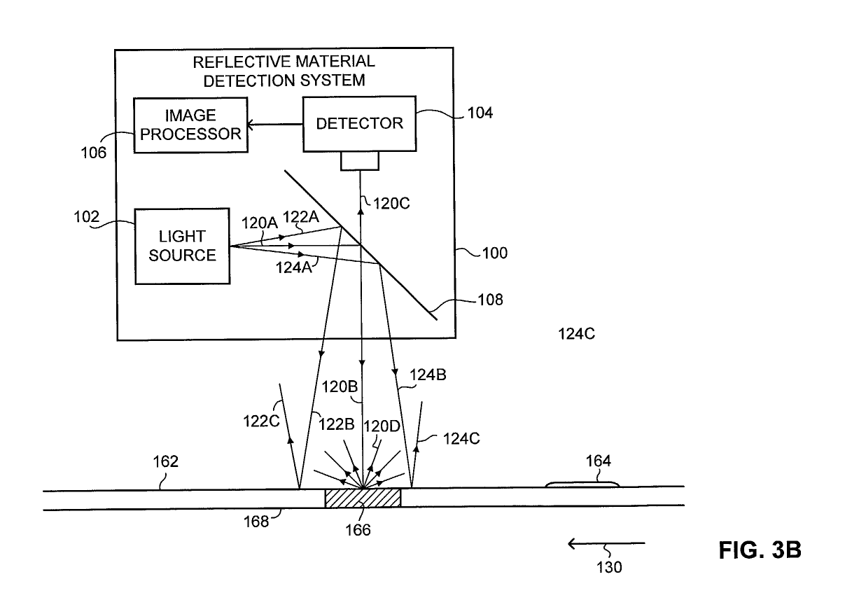

FIG. 3A is an illustration of another reflective moving sample and the detection system of FIG. 2A;

FIG. 3B is an illustration of a moving sample partly reflective and partly diffusive, and the detection system of FIG. 2A;

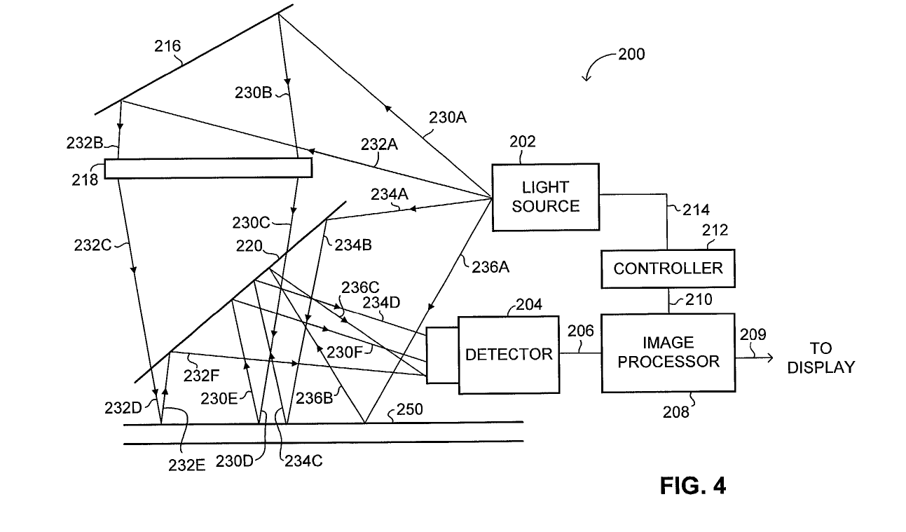

FIG. 4 is a schematic illustration of a partly reflective partly diffusive sample and a detection system, constructed and operative in accordance with another preferred embodiment of the present invention;

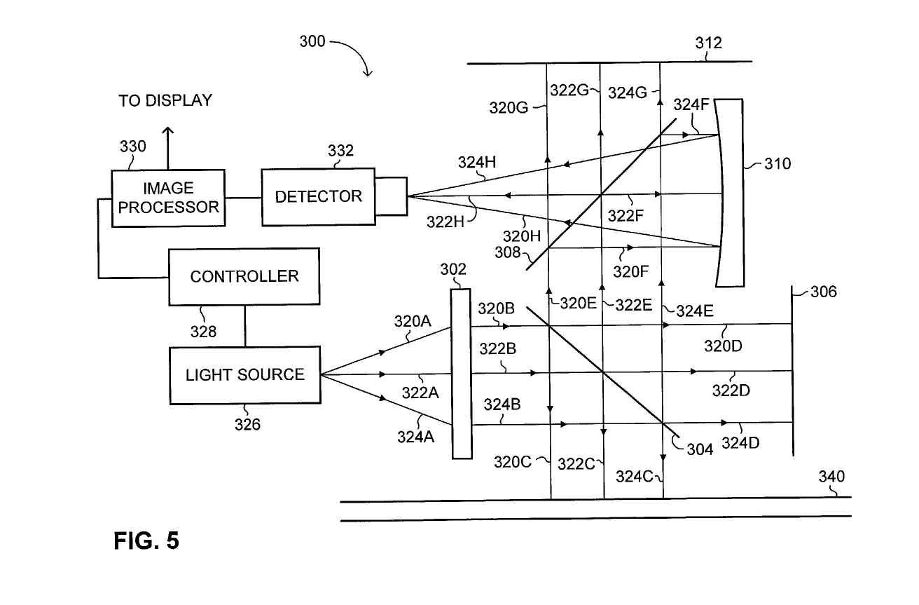

FIG. 5 is a schematic illustration of a reflective sample and a detection system, constructed and operative in accordance with a further preferred embodiment of the present invention; and

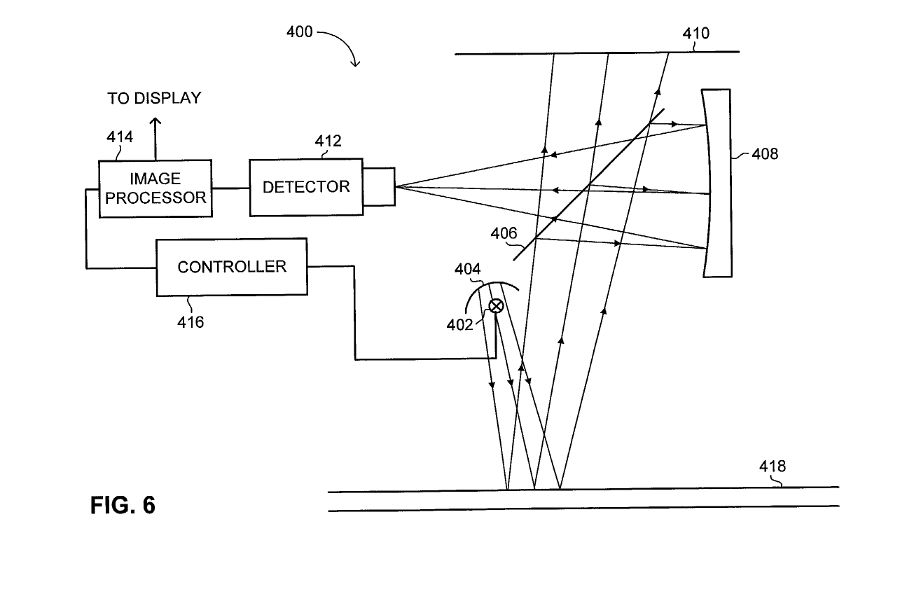

FIG. 6 is a schematic illustration of a reflective sample and a detection system, constructed and operative in accordance with another preferred embodiment of the present invention.

### DETAILED DESCRIPTION OF THE INVENTION

The detailed description of the invention is generally applicable to optical devices for detection of surface anomalies. In particular, the description is concerned with detection of changes in surface properties of continuous strips of reflective materials, and defects in objects moving on a conveyor system. Such surface properties include printed matter in a press, detection of lacquer quality and thickness thereof on printed matter, cold seal of packages, and color of metals. Defects include burrs and corrosion on metals, and defects in sharp edges of knives. The device according to the present invention can differentiate among colors on a reflective surface.

The present invention overcomes the disadvantages of the prior art by providing a system in which the final illuminating beam and the detection line of sight are located on the same axis, perpendicular to the scanned work-piece.

Reference is now made to FIGS. 2A, 2B and 2C. FIG. 2A is a schematic illustration of a moving sample, generally referenced 150, having a transparent coating and a detection system, generally referenced 100, constructed and operative in accordance with a preferred embodiment of the present invention. FIGS. 2B and 2C are schematic illustrations of the moving sample 150 and the detection system 100 of FIG. 2A, at different positions.

Detection system 100 includes a light source 102, a transparent mirror 108, a detector 104, and an image processor 106. Light source 102 can be an incandescent, halogen, fluorescent, mercury vapor, metal halide, high pressure sodium, low pressure sodium lamp, a light emitting diode, laser, a semiconductor device, and the like. Furthermore, light source 102 can create coherent or incoherent beams of light in any frequency within and including the infrared and ultraviolet frequencies.

Transparent mirror 108 is a mirror that reflects part of the light beam falling on it, and transmits part. Transparent mirror 108 faces light source 102 in an inclined position. Detector 104 is an optic detector such as a Charge Coupled Device (CCD), a photoemissive tube, and the like. Detector 104 is located behind transparent mirror 108, such that line of sight of detector 104 is perpendicular to the beam emanating from light source 102. Image processor 106 is an electronic unit that converts video signal to electric current. Detector 104 inputs a video signal to image processor 106.

Moving sample 150 is positioned below detector system 100, and moves in a direction designated by arrow 130. Moving sample 150 includes a transparent and reflective coating 152. Moving sample 150 includes foreign particles 154A, and 154B. Foreign particle 154A is located below coating 152, and foreign particle 154B is located above coating 152. Both foreign particles 154A and 154B are located to the right of detection system 100, and foreign particle 154B is to the right of foreign particle 154A. Detection system 100 detects foreign particles 154A and 154B at specific positions of moving sample 150, with respect to detection system 100.

Light source 102 directs diverging beams of light 120A, 122A, and 124A, to transparent mirror 108. Transparent mirror 108 reflects beams 120A, 122A, and 124A, as beams 120B, 122B, 124B, respectively, and directs them to sample 150. Coating 152 reflects diverging beams 122B, and 124B, sideways, as beams 122C, and 124C, respectively, and therefore beams 122C, and 124C, do not reach the transparent mirror 108. Normal light beam 120B, penetrates coating 152, and reaches the moving sample 150. Moving sample 150 reflects normal light beam 120B, perpendicularly in the original path of light beam 120B. Normal light beam reflected from moving sample 150, passes through transparent mirror 108, and reaches detector 104 as light beam 120C. Detector 104 detects light beam 120C, and generates a video signal, which is then processed by image processor 106.

It is noted that foreign particles 154A, and 154B, are located to the right of normal light beam 120B. Therefore, normal light beam 120B, does not reach foreign particles 154A, and 154B, and detector 104 does not detect foreign particles 154A and 154B. Likewise, image processor 106 reports that moving sample 150 is free from foreign particles. If foreign particle 154B is located at a horizontal position similar to foreign particle 154A, likewise it is not detected by detector 104. Light rays 122C, and 124C are again reflected sideways, and do not reach detector 104.

With reference to FIG. 2B, moving sample 150 is in an advanced position with respect to its position in FIG. 2A. Moving sample 150 is in such state that foreign particle 154A is partly located under normal light beam 120B. Therefore, foreign particle 154A reflects the normal light beam 120B, sideways, as light beam 120C, which does not reach detector 104. In this case too, as in FIG. 2A, the image processor 106 reports that moving sample 150 is free from foreign particles.

With reference to FIG. 2C, the moving sample 150 is in a further advanced position with respect to its position in FIG. 2B. Moving sample 150 is in such state that foreign particle 154A is directly located under normal light beam 120B. Foreign particle 154A reflects normal light beam 120B, perpendicularly in the original path of light beam 120B. Normal light beam reflected from foreign particle 154A, passes through transparent mirror 108, and reaches detector 104 as light beam 120C. Detector 104 detects light beam 120C, image processor 106 senses a change in the incoming signal, and reports that foreign particle 154A is present. If foreign particle 154B is located at a horizontal position similar to particle 154A, likewise it is detected by detector 104.

Reference is now made to FIG. 3A, which is an illustration of a reflective moving sample, generally referenced 160 and the detection system 100 of FIG. 2A. Sample 160 is a substantially reflective matter, such as aluminum foil, moving under detection system 100, in a direction, normal to detection system 100. A stripe of cold seal 164 is located on top of sample 162, normal to direction of movement of sample 160. Moving sample 160 is in such position with respect to detection system 100, that the cold seal 164 is located directly below normal light beam 120B. Cold seal 164 reflects normal light beam 120B, perpendicularly in the original path of light beam 120B. Normal light beam reflected from cold seal 164, passes through transparent mirror 108, and reaches detector 104 as light beam 120C. Detector 104 detects light beam 120C, and image processor 106 reports that cold seal 164 is present.

Reference is further made to FIG. 3B, which is an illustration of a moving sample partly reflective and partly diffusive, generally referenced 168 and the detection system 100 of FIG. 2A. Moving sample 168 includes a non-reflective diffusive section 166. Normal light ray 120B striking the surface of diffusive section 166, is diffusively reflected as light rays 120D, and therefore light rays 120D do not reach detector 104. As described with reference to FIG. 3A, light rays 122C and 124C are reflected sideways, and do not reach detector 104 neither. Therefore, detection system 100 can differentiate between a reflective section of moving sample 168 (for instance cold seal 164 as described with reference to FIG. 3A), and a diffusive section 166.

If surface of section 166 is reflective, but less reflective than cold seal 164, part of the light rays 120D reflected from surface of section 166 reach detector 104, whereas as described with reference to FIG. 3A, light ray 120B is perpendicularly reflected from (reflective) cold seal 164, and light ray 120B is entirely detected by detector 104. For example, if surface of cold seal 164 is 90% reflective, and surface of section 166 is 80% reflective, then, respectively 90% and 80% of light ray 120B is reflected from cold seal 164 and section 166, and respectively 90% and 80% of light ray 120C reach detector 104. Therefore, the intensity of light ray 120B reflected from surface of section 166, and reaching detector 104, is less than the intensity of light ray 120B reflected from cold seal 164. The detector 104 generates video signals, which are different for light rays of different intensities, detected thereby. Thus, detection system 100 of FIG. 3B can differentiate surfaces of different reflectivities. Similarly, detection system 100 of FIG. 3A can detect cold seal 164, because the reflectivity of cold seal 164 and surface 162 of moving sample 160 are different.

Reference is now made to FIG. 4, which is a schematic illustration of a partly reflective partly diffusive sample, generally referenced 250 and a detection system, generally referenced 200, constructed and operative in accordance with another preferred embodiment of the present invention. Detection system 200 includes a light source 202, a detector 204, an image processor 208, a controller 212, a mirror 216, a condenser 218, and a transparent mirror 220.

Light source 202, is an ordinary or a flashing light bulb, or a chromatic or monochromatic light bulb, or a halogen lamp and the like, having constant or variable intensity. Detector 204 is an optic detector such as a Charge Coupled Device (CCD), a television camera, and the like. Image processor 208 is an electronic unit that converts video signal to electric current. Controller 212 controls the operating parameters of light source 202, such as intensity, wavelength, duration, and frequency of illumination, according to signals received from image processor 208. Mirror 216 is a flat mirror that reflects light beams. Condenser 218 consists of two Fresnel lenses, and it condenses light beams. Transparent mirror 220 is a mirror that reflects part of the light beam falling on it, and transmits part.

Mirror 216 is positioned to the left and slightly above light source 202, and at an angle to the horizon, in order to reflect the light beams it receives from light source 202, to condenser 218. Condenser 218 is positioned horizontally below mirror 216. Sample 250 is below the detection system 200. Transparent mirror 220 is located below condenser 218, at an angle to the horizon, in order to direct light beams reflected from sample 250, to detector 204. Detector 204 is positioned to the right of transparent mirror 220, and above sample 250. Image processor 208 is connected between detector 204, and controller 212. Light source 202 in turn is connected to controller 212.

Light source 202 directs diverging light beams 230A, and 232A, to mirror 216, for inspection of a reflective section of sample 250. Mirror 216 reflects light beams 230A, and 232A, as light beams 230B, and 232B, respectively, to condenser 218. Condenser 218 condenses light beams 230B, and 232B, to light beams 230C, and 232C, respectively. Light beams 230C, and 232C, pass through transparent mirror 220, and strike the sample 250 as light beams 230D, and 232D, respectively. Sample 250 reflects light beams 230D, and 232D, as light beams 230E, and 232E, respectively, and strike transparent mirror 220. Transparent mirror 220 reflects light beams 230E, and 232E, as light beams 230F, and 232F, respectively. Light beams 230F, and 232F, in turn enter detector 204.

Detector 204 detects light beams 230F, and 232F, and outputs video signal 206. Image processor 208 converts video signal 206 to electric signals 209, and 210. Signal 209 is input to a display unit (not shown), that displays the image detected by detector 204. Controller 212 controls functional parameters of light source 202, such as intensity, wavelength, duration, and frequency of illumination through a signal 214 to light source 202. Furthermore, image processor 208 can supply feedback signal 210 to controller 212.

Light source 202 directs diverging light beams 234A, and 236A, for inspection of a diffusive section of sample 250. Transparent mirror 220 reflects light beam 234A, as light beam 234B. Sample 250 diffusively reflects light beam 234B as light beam 234C. Transparent mirror 220 reflects light beam 234C, as light beam 234D, and detector 204 detects light beam 234D. Sample 250 diffusively reflects light beam 236A, as light beam 236B. Transparent mirror 220 reflects light beam 236B, as light beam 236C, and detector 204 detects light beam 236C. light beams 230A, 232A, 234A, and 236A are in phase. Therefore, detector 204 can simultaneously

Detection system 200 can determine quality of color prints having transparent and reflective coatings, as well as quality of reflective colors. Detection system 200 further determines thickness of reflective coatings, such as lacquer. This is due to the fact that intensity of light beams reflected off a transparent coating, and reaching a detector, is a function of thickness of the coating. Detection system 200, further yet determines quality of metallic articles having a reflective surface, such as knife-edges, corrosion, and burrs on a machined mechanical part. Furthermore, detection system 200, determines changes in surface properties, such as an unreflective cold seal on a reflective substance, and changes in color on a reflective metal surface.

The present invention also provides means for controlling the resolution of an image of sample 250 detected by detector 204. The resolution of the image is controlled by varying either the diameter of an aperture (not shown) of light source 202, through which the light rays exit light source 202, or the diameter of an aperture (not shown) of detector 204 through which light rays enter detector 204. The aperture may be of the type employed in still image cameras, and the diameter of the aperture may be changed by methods known in the art, such as by an electric motor, and the like. The smaller the aperture of light source 202 or detector 204, the greater the resolution and brightness of an image of sample 250 detected by detector 204. It is noted that detection system 200 may be employed for detecting stationary samples.

It may be appreciated by those skilled in the art, that one advantage of detection system 200 is that while employing a strobing light source, no synchronization between light beams 230A and 234A, or between 232A and 236A is needed. Furthermore, light beams 230A and 232A have the same spectrum as light beams 234A and 236A, since they originate from a single light source.

Reference is now made to FIG. 5, which is a schematic illustration of a detection system, generally referenced 300, and a reflective sample, generally referenced 340, constructed and operative in accordance with another preferred embodiment of the present invention. Detector system 300 includes a light source 326, a detector 332, an image processor 330, and a controller 328, as described in connection with FIG. 4. Detection system 300, further includes a Fresnel condenser 302, a transparent mirror 304, a black screen 306, a transparent mirror 308, a concave mirror 310, and a black screen 312.

Fresnel condenser 302, converts diverging light beams, to parallel light beams. Transparent mirror 304 is a mirror that reflects part of the light beam falling on it, and transmits part. Transparent mirror 308, is identical to transparent mirror 304. Screen 306, is a substantially flat screen of flat black color, which absorbs the incident light. Screen 312, is identical to screen 306. Concave mirror 310, focuses the incoming parallel light beams at its focal point.

The interconnections of the light source 326, the detector 332, the image processor 330, and the controller 328, are identical to those described in connection with FIG. 4. Sample 340 is located below detection system 300. Fresnel condenser 302 is positioned vertically to the right of light source 326. Transparent mirror 304, is positioned to the right of Fresnel condenser 302, generally at 45 degrees to the vertical and in a negative slope, in order to reflect the parallel light beams coming from the Fresnel condenser 302, vertically onto sample 340. Screen 306 is positioned vertically to the right of transparent mirror 304, in order to absorb the light beams coming from transparent mirror 304, and prevent their reflection. Transparent mirror 308, is positioned directly above transparent mirror 304, generally at 45 degrees to the vertical and in a positive slope, in order to reflect the parallel light beams reflected from sample 340, vertically onto the concave mirror 310. Concave mirror 310, is positioned vertically to the right of transparent mirror 308, with its concave side pointing towards transparent mirror 308, in order to focus the parallel light beams reflected from transparent mirror 308, at the lens of detector 332. Detector 332 is positioned to the left of transparent mirror 308, in order to receive the converging light beams, reflected from concave mirror 310. Screen 312 is positioned horizontally above transparent mirror 308, in order to absorb the light beams reflected from sample 340, and passing through transparent mirrors 304, and 308, and prevent their reflection.

Light source 326, directs diverging light beams 320A, 322A, and 324A, to Fresnel condenser 302. Fresnel condenser 302 converts light beams 320A, 322A, and 324A, to parallel and horizontal light beams 320B, 322B, and 324B, respectively. Transparent mirror 304, reflects light beams 320B, 322B, and 324B, to parallel and vertical light beams 320C, 322C, and 324C, respectively, on to sample 340. Sample 340, reflects light beams 320C, 322C, and 324C, vertically in their original path. Part of light beams 320B, 322B, and 324B, pass through transparent mirror 304, exit as light beams 320D, 322D, and 324D, and are absorbed by the screen 306.

Light beams 320C, 322C, and 324C, reflected from sample 340, pass through transparent mirror 304, and exit as light beams 320E, 322E, and 324E, respectively. Transparent mirror 308, reflects light beams 320E, 322E, and 324E, to parallel and horizontal light beams 320F, 322F, and 324F, respectively, on to concave mirror 310. Part of light beams 320E, 322E, and 324E, pass through transparent mirror 308, exit as light beams 320G, 322G, and 324G, and are absorbed by screen 312. Concave mirror 310, reflects the parallel and horizontal light beams 320F, 322F, and 324F, as converging light beams 320H, 322H, and 324H, respectively, onto detector 332.

Reference is further made to FIG. 6, which is a schematic illustration of a detection system, generally referenced 400, and a reflective sample, generally referenced 418, constructed and operative in accordance with another preferred embodiment of the present invention. Detection system 400 is substantially similar to system 300 of FIG. 5, except that light source 326 and the Fresnel condenser 302, are replaced by a light source 402 and a reflector 404.

System 400 includes a transparent mirror 406, a concave mirror 408, a black screen 410, a detector 412, an image processor 414, and a controller 416, which are substantially similar to the respective components described in connection with FIG. 5. Light beams exit the reflector, strike sample 418, at substantially right angles thereto, and are reflected therefrom at substantially right angles. The light beams reflected from sample 418, follow a path substantially similar to that depicted in FIG. 5, and are detected by detector 412. It is noted that concave mirror 408 produces an image of light source 402 on detector 412.

It will be appreciated by persons skilled in the art that the present invention is not limited to what has been particularly shown and described herein above. Rather the scope of the present invention is defined only by the claims, which follow.

1. System for inspecting a surface, the system comprising:
a light source;
a first transparent mirror; and
a detector,
wherein said light source projects a first light beam on said first transparent mirror, said first transparent mirror reflects said first light beam towards said surface in a direction normal to said surface,
wherein said detector detects a second light beam reflected from said surface, in a normal direction, through said first transparent mirror.

2. The system according to claim 1, further comprising an image processor, connected to said detector, for processing at least one image detected by said detector.

3. The system according to claim 1, further comprising a controller connected to said light source, said controller controlling a property of said light source selected from a list consisting of:
size of aperture;
illumination intensity;
radiation wavelength;
illumination duration; and
intervals of illumination.

4. The system according to claim 1, further comprising a controller connected to said detector, said controller controlling size of the aperture of said detector.

5. The system according to claim 1, wherein said detector is a charge coupled device (CCD).

6. The system according to claim 1, wherein said detector is a television camera.

7. The system according to claim 1, wherein said surface is stationary.

8. The system according to claim 1, wherein said surface is moving.

9. The system according to claim 1, further comprising an optical condenser, located between said light source and said first transparent mirror.

10. The system according to claim 1, further comprising a first screen located in sequence with said optical condenser and said first transparent mirror, along an axis, said axis being determined by said light source and said first transparent mirror.

11. The system according to claim 1, further comprising:
a second transparent mirror, located in sequence with said surface and said first transparent mirror, on an axis normal to said surface, said axis being determined by said first transparent mirror; and
a concave mirror located along an axis determined by said detector and said second transparent mirror;
wherein said second transparent mirror reflects said second light beam towards said concave mirror, said detector detects a light beam reflected from said concave mirror through said second transparent mirror.

12. The system according to claim 1, further comprising a second screen located in sequence with said first transparent mirror and said second transparent mirror on an axis normal to said surface.

13. Method for inspecting a surface, the method comprising the steps of:
projecting a first light beam by a light source on a first transparent mirror;
reflecting at least a portion of said first light beam by said first transparent mirror, in a direction normal to said surface; and
detecting a second light beam reflected by said surface in a normal direction through said first transparent mirror.

14. The method according to claim 13, further comprising the step of collimating said first light beam.

15. The method according to claim 13, further comprising the step of absorbing a passing portion of said first light beam, passing through said first transparent mirror.

16. The method according to claim 13, further comprising the step of reflecting at least a portion of said second light beam by a second transparent mirror, towards a concave mirror.

17. The method according to claim 13, further comprising the step of absorbing a passing portion of said second light beam, passing through said second transparent mirror.

18. The method according to claim 13, further comprising the step of detecting a light beam reflected by said concave mirror through said second transparent mirror.

19. System for inspecting a surface, the system comprising:
a detector;
a light source located in sequence with said surface and said detector;
a transparent mirror; and
a mirror located in sequence with said surface and said transparent mirror,
wherein said mirror reflects a first light beam received from said light source, towards said surface through said transparent mirror, in a direction normal to said surface, and
wherein said transparent mirror reflects light towards said detector, said light being initially reflected from said surface.

20. The system according to claim 19, wherein said transparent mirror reflects a second light beam, received from said light source, towards said surface.

21. The system according to claim 19, wherein said surface receives a third light beam from said light source.

22. The system according to claim 20, wherein said surface receives a third light beam from said light source.

23. The system according to claim 19, further comprising an optical condenser located between said mirror and said transparent mirror, wherein said optical condenser collimates a reflection of said first light beam, from said mirror towards said surface.

24. The system according to claim 20, further comprising an optical condenser located between said mirror and said transparent mirror, wherein said optical condenser collimates a reflection of said first light beam, from said mirror towards said surface.

25. The system according to claim 21, further comprising an optical condenser located between said mirror and said transparent mirror, wherein said optical condenser collimates a reflection of said first light beam, from said mirror towards said surface.

26. The system according to claim 22, further comprising an optical condenser located between said mirror and said transparent mirror, wherein said optical condenser collimates a reflection of said first light beam, from said mirror towards said surface.

27. The system according to claim 19, further comprising an image processor, connected to said detector, for processing at least one image detected by said detector.

28. The system according to claim 19, further comprising a controller connected to said light source, said controller controlling a property of said light source selected from a list consisting of:
size of aperture;
illumination intensity;
radiation wavelength;
illumination duration; and
intervals of illumination.

29. The system according to claim 19, further comprising a controller connected to said detector, said controller controlling size of the aperture of said detector.

30. The system according to claim 19, wherein said detector is a charge coupled device (CCD).

31. The system according to claim 19, wherein said detector is a television camera.

32. The system according to claim 19, wherein said surface is stationary.

33. The system according to claim 19, wherein said surface is moving.

34. System for inspecting a surface, the system comprising:
a light source;
a detector;
a transparent mirror; and
a concave mirror located in sequence with said detector and said transparent mirror,
wherein said light source projects a light beam towards said surface, said transparent mirror reflects a portion of light towards said concave mirror, said light being reflected from said surface, said concave mirror directs said portion of light towards said detector through said transparent mirror, said detector detects said portion of light.

35. The system according to claim 34, further comprising a screen located in sequence with said transparent mirror and said surface on an axis normal to said surface.

36. Method for inspecting a surface, comprising the steps of:
reflecting a first light beam, towards said surface, through a transparent mirror;
reflecting light, reflected from said surface, by said transparent mirror towards a detector; and
detecting said light by said detector.

37. The method according to claim 36, further comprising the step of reflecting a second light beam by said transparent mirror towards said surface,
wherein said first light beam and said second light beam are produced by a single light source.

38. The method according to claim 36, further comprising the step of projecting a third light beam towards said surface,
wherein said first light beam and said third light beam are produced by a single light source.

39. The method according to claim 37, further comprising the step of projecting a third light beam towards said surface,
wherein said third light beam is produced by said single light source.

40. The method according to claim 36, further comprising the step of collimating a reflection of said first light beam.
